(19) United States
(12) Patent Application Publication
(10) Pub. No.: US 2023/0379392 A1
(43) Pub. Date: Nov. 23, 2023

(54) METHODS AND SYSTEMS FOR MANAGING SERVICE ENABLER ARCHITECTURE LAYER (SEAL) SERVICES

(71) Applicant: Samsung Electronics Co., Ltd., Suwon-si, Gyeonggi-do (KR)

(72) Inventors: Narendranath Durga TANGUDU, Bangalore (IN); Nishant GUPTA, Bangalore (IN); Basavaraj Jayawant PATTAN, Bangalore (IN); Sapan Pramodkumar SHAH, Bangalore (IN); Kiran GAJULA, Bangalore (IN); Sreekanth Vadakkepurakkal CHANDRAN, Bangalore (IN)

(21) Appl. No.: 18/030,411

(22) PCT Filed: Oct. 5, 2021
(86) PCT No.: PCT/KR2021/013621

§ 371 Date: Apr. 5, 2023

(30) Foreign Application Priority Data
Oct. 6, 2020 (IN) 202041043384
Sep. 20, 2021 (IN) 2020 41043384

(51) Int. Cl. H04L 67/51; H04L 67/52

(52) U.S. Cl. CPC H04L 67/51; H04L 67/52

(57) ABSTRACT

The present disclosure relates to a 5G communication system or a 6G communication system for supporting higher data rates beyond a 4G communication system such as long term evolution (LTE). A method disclosed herein includes receiving, by a group management server, a request from a group management client for creating at least one Vertical Application Layer (VAL) group. The method further includes creating, by the group management server, the at least one VAL group. The method further includes obtaining, by the group management server, external group identifier information for identifying a group of member User Equipments (UEs) of the at least one VAL group at a 3rd Generation Partnership Project (3GPP) core network. The method further includes sending, by the group management server, a creation response to the group management client, on obtaining the external group identifier information for the created at least one VAL group.

### CROSS-REFERENCE TO RELATED APPLICATION(S)

This application is a U.S. National Stage application under 35 U.S.C. § 371 of an International application number PCT/KR2021/013621, filed on Oct. 5, 2021, which is based on and claimed priority of an Indian Provisional patent application number 202041043384, filed on Oct. 6, 2020, in the Indian Intellectual Property Office, and an Indian Complete patent application number 202041043384, filed on Sep. 20, 2021, in the Indian Intellectual Property Office, the disclosure of each of which is incorporated by reference herein in its entirety.

### TECHNICAL FIELD

The present disclosure relates to the field of Service Enabler Architecture Layer (SEAL) services and more particularly to managing SEAL services to support external group identifier information for member User Equipments (UEs) of a Vertical Application Layer (VAL) group.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Current versions of 3^{rd} Generation Partnership Project (3GPP) involve identification of application architecture aspects to support a Factories of the Future (FF) in a 5G network and corresponding architecture solutions. The identification of application architecture aspects is necessary to ensure efficient use and deployment of an application layer support for the FF in the 5G network. The 3GPP specification TR 23.745 proposes various use cases like 5G Local Area Network (LAN) group management, device monitoring, Quality of Service (QoS) monitoring, and so on, which illustrate leveraging SEAL (Service Enabler Architecture Layer for verticals) services (as specified in the 3GPP specification TS 23.434) to fulfill requirements of the FF with an assistance of a 5G core network (5GC).

The above described various use cases require an interaction of a SEAL server with the 5GC via a Network Exposure Function (NEF), as specified in the 3GPP TS 29.522. To invoke any NEF/Service Capability Exposure Function (SCEF) Application Program Interfaces (APIs), a SEAL server/layer has to identify a User Equipment (UE) or a group of UEs, for which the NEF/SCEF APIs are invoked. Alternatively, to invoke any NEF/SCEF APIs, an FF application server has to identify the UE or the group of UEs. The NEF/SCEF APIs (like monitoring API and like so) support external group identifiers, as specified in the 3GPP specification TS 23.682 (clause 4.6,3). The external group identifier maps to an International Mobile Subscriber Identity (IMSI)-Group Identifier(s) (as defined in the 3GPP specification TS 23.003), which have been stored in Home Subscriber Server (HSS)/Unified data management (UDM). As per the 3GPP TS 23.682 (clause 4.6.3), the HSS/UDM may be able to resolve the external group identifier to the IMSI-group identifier and an associated external identifier or mobile subscriber Integrated Services Digital Network (MSISDN) number for each of the IMSIs in the IMSI group. However, in accordance with the current versions of the 3GPP specification, the FF application server and the SEAL server may not provide identification of the group of UEs to the NEF/SCEF. The FF application server and the SEAL server need a mechanism to provide the identification of the group of UEs to the NEF/SCEF for the invoking the APIs. Thus, the current versions of the 3GPP specification do not clearly discloses how the SEAL server uses the external group identifier managed by the 5GC for Vertical Application Layer (VAL) groups, wherein each VAL group includes the UE or the group of UEs. For example, when the SEAL server has to monitor the 5GC for events related to the UEs of the VAL/SEAL groups, the SEAL server has to invoke the NEF API as specified in the 3GPP TS 29.522 to receive the assistance from the 5GC (i.e., to receive core network events). One of parameters of subscribing to the NEF API is the external group identifier. However, in the current versions of the 3GPP specification, the VAL/SEAL groups do not support the external group identifier.

Apart from the FF, the 3GPP also specifies enabling of various industry vertical's communication like Uncrewed Aerial Systems, Vehicle to Everything, and so on, over the 5G network. The FF application server supports for the above described vertical communications and also requires the interaction with the 5GC via the NEF to fulfill vertical specific requirements. Therefore, the above described problems may also be applicable for every vertical specific application that wishes to leverage the SEAL server for interaction with the 5GC via the NEF APIs or the application server that wishes to interact with the 5GC via the NEF APIs.

### DISCLOSURE OF INVENTION

### Technical Problem

The principal object of the embodiments herein is to disclose methods and systems for managing Service Enabler Architecture Layer (SEAL) services to support external group identifier information identifying a group of member User Equipments (UEs) of a Vertical Application Layer (VAL) group at a 3^{rd} Generation Partnership Project (3GPP) core network.

Another object of the embodiments herein is to disclose methods and systems for updating the external group identifier information on performing group management procedures like read, update, delete or the like.

Another object of the embodiments herein is to disclose methods and systems for enabling a VAL/Factories of Future (FF) application server to provision the VAL group with the external group identifier information identifying the group of UEs.

Another object of the embodiments herein is to disclose methods and systems for enabling SEAL/VAL/FF application servers to invoke any Network Exposure Function (NEF)/Service Capability Exposure Function (SCEF) Application Programming Interfaces (APIs) based on the external group identifier information related with the VAL group.

Another object of the embodiments herein is to disclose methods and systems for enabling the SEAL/FF application/VAL server to fetch and update the external group identifier information of the VAL group from the 3GPP core network.

Another object of the embodiments herein is to disclose methods and systems for enabling the FF application/VAL server to query for the external group identifier information depending on a VAL group identifier (ID) and VAL group information based on the external group identifier information.

### Solution to Problem

Accordingly, the embodiments herein provide methods and systems for managing Service Enabler Architecture Layer (SEAL) services. A method disclosed herein includes receiving, by a group management server, a request from a group management client for creating at least one Vertical Application Layer (VAL) group. The method further includes creating, by the group management server, the at least one VAL group. The method further includes obtaining, by the group management server, external group identifier information for identifying a group of member User Equipments (UEs) of the at least one VAL group at a 3rd Generation Partnership Project (3GPP) core network. The method further includes sending, by the group management server, a creation response to the group management client, on obtaining the external group identifier information for the created at least one VAL group.

Accordingly, the embodiments herein provide a Service Enabler Architecture Layer (SEAL) system comprising a group management server and a group management client. The group management server is configured to receive a request from a group management client for creating at least one Vertical Application Layer (VAL) group. The group management server is configured to create the at least one VAL group. The group management server is configured to obtain external group identifier information for identifying a group of member User Equipments (UEs) of the at least one VAL group at a 3rd Generation Partnership Project (3GPP) core network. The group management server is configured to send a creation response to the group management client, on obtaining the external group identifier information for the created at least one VAL group.

Accordingly, the embodiments herein provide a group management server in a Service Enabler Architecture Layer (SEAL) system, wherein the group management server comprises a memory and a controller coupled to the memory. The controller is configured to receive a request from a group management client for creating at least one Vertical Application Layer (VAL) group. The controller is configured to create the at least one VAL group. The controller is configured to obtain external group identifier information for identifying a group of member User Equipments (UEs) of the at least one VAL group at a 3rd Generation Partnership Project (3GPP) core network. The controller is configured to send a creation response to the group management client, on obtaining the external group identifier information for the created at least one VAL group.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 depicts a Service Enabler Architecture Layer (SEAL) system, according to embodiments as disclosed herein;

FIG. 2 depicts functional entities of the SEAL system, according to embodiments as disclosed herein;

FIG. 3 depicts a group management server of the SEAL system, according to embodiments as disclosed herein;

FIG. 4 is an example block diagram depicting components of the group management server to enhance the SEAL services by supporting external group identifier information for a Vertical Application Layer (VAL) group, according to embodiments as disclosed herein;

FIG. 5 depicts a controller of the group management server to enhance the SEAL services, according to embodiments as disclosed herein;

FIG. 6 is an example block diagram depicting components of a group management client for invoking Application Programming Interfaces (APIs), according to embodiments as disclosed herein;

FIG. 7 is an example conceptual diagram depicting enhancement of the SEAL services by supporting the external group identifier information for the VAL group, according to embodiments as disclosed herein;

FIG. 8 is a sequence diagram depicting creation of the VAL group supporting the external group identifier information, according to embodiments as disclosed herein;

FIG. 9 is an example sequence diagram depicting creation of the VAL group supporting the external group identifier information, wherein the VAL group is a location-based VAL group, according to embodiments as disclosed herein;

FIG. 10 is an example diagram depicting creation of the VAL group on receiving a configure VAL group request, according to embodiments as disclosed herein;

FIG. 11 is an example diagram depicting updating of the VAL group, according to embodiments as disclosed herein;

FIG. 12 is an example sequence diagram depicting de-registration of the VAL group, according to embodiments as disclosed herein;

FIG. 13 is an example sequence diagram depicting fetching or updating the external group identifier information during a store group configuration procedure, according to embodiments as disclosed herein;

FIG. 14 is an example sequence diagram depicting creation of the location-based VAL group based on the group creation request including the external group identifier information, according to embodiments as disclosed herein;

FIG. 15 is an example diagram depicting creation of the VAL group on receiving the configure VAL group request including the external group identifier information, according to embodiments as disclosed herein;

FIG. 16 is an example diagram depicting updating of the VAL group based on the group membership update request including the external group identifier information, according to embodiments as disclosed herein;

FIG. 17 is an example sequence diagram depicting performing the store group configuration procedure based on the store group configuration request including the external group identifier information, according to embodiments as disclosed herein;

FIG. 18 is an example sequence diagram depicting procedures for a Factories of Future (FF) application server or a VAL server or a SEAL server to fetch, update, and delete the external group identifier information from a 3GPP core network either directly or via a Network Exposure Function (NEF)/Service Capability Exposure Function (SCEF) entity, according to embodiment as disclosed herein;

FIG. 19 is an example sequence diagram depicting retrieval of the external group identifier information from the group management server, according to embodiments as disclosed herein; and

FIG. 20 is an example sequence diagram depicting retrieval of information of the VAL group based on the associated external group identifier information, according to embodiments as disclosed herein.

### MODE FOR THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

Embodiments herein disclose methods and systems for enhancing/managing Service Enabler Architecture Layer (SEAL) services to support external group identifier information, thus enabling capabilities of a 3rd Generation Partnership Project (3GPP) core network for Vertical Application Layer (VAL) groups. The external group identifier information may identify a set of User Equipments (UEs) mapped to a VAL group document at the 3GPP core network, where the UEs identified by the external group identifier information are member UEs of the VAL group.

Embodiments herein disclose methods and systems for updating the external group identifier information corresponding to the member UEs of the VAL group, on performing group management procedures like create, update, read, delete, or the like.

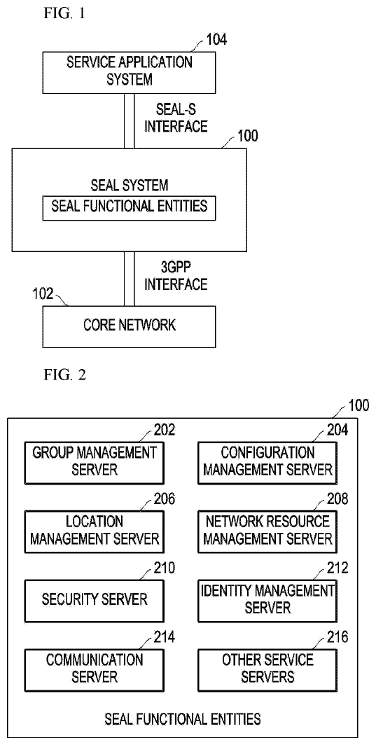

Referring now to the drawings, and more particularly to FIGS. 1 through 20, where similar reference characters denote corresponding features consistently throughout the figures, there are shown example embodiments.

FIG. 1 depicts a Service Enabler Architecture Layer (SEAL) system 100, according to embodiments as disclosed herein. The SEAL system 100 referred herein may be configured to provide a plurality of functionalities/SEAL services, which may be used in multiple vertical applications/communications. Examples of the functionalities/SEAL services may be, but are not limited to, group management, configuration management, identity management, group communication, multimedia broadcast and multicast, security and key management, location management, network resource management, or any other functionalities specific to requirements of service verticals offered over a 3GPP network. Examples of the 3GPP network may be, but are not limited to, a Long Term Evolution (LTE/4G), an LTE-Advanced (LTE-A), a Fifth Generation (5G) New Radio (NR), a Wireless Local Area Network (WLAN), Code Division Multiple Access (CDMA), Frequency Division Multiple Access (FDMA), Time Division Multiple Access (TDMA), Orthogonal Frequency Division Multiple Access (OFDMA), General packet radio service (GPRS), Enhanced Data rates for GSM Evolution (EDGE), Universal Mobile Telecommunications System (UMTS), Enhanced Voice-Data Optimized (EVDO), High Speed Packet Access (HSPA), HSPA plus (HSPA+), Wireless Local Area Network (WLAN), Worldwide Interoperability for Microwave Access (WiMAX/IEEE 802.16), Wi-Fi (IEEE 802.11), Evolved-UTRA (E-UTRA), Wi-Fi Direct, or any other next generation networks. Examples of the vertical applications may be, but are not limited to, public safety applications, automotive applications, health logistics, and so on.

The SEAL system 100 may also be configured to provision inter-services communications by receiving a request from a service application for accessing the one or more functionalities, determining the one or more functionalities requested by the service application based on the request, and providing the one or more functionalities to the service application based on the inter-services communication.

The SEAL system 100 may be connected to a 3GPP core network 102, and a service application system 104 for providing the one or more functionalities/SEAL services. The 3GPP core network 102 may be one of, an Evolved Packet System (EPS) core network, a 5G core network (5GC), or any other next generation core network. The SEAL system 100 is connected to the 3GPP core network 102 through a 3GPP interface. Examples of the 3GPP interface may be, but are not limited to, T8, N33 and or any other similar interface. The 3GPP interface may be used for requesting signaling control and media control associated with functionalities offered by the 3GPP interface.

The service application system 104 (may also be referred as a vertical service provider 104 or a SEAL service provider 104) includes one or more service application servers (not shown) to provide the vertical applications (also be referred as service applications, service verticals, or the like) such as, but are not limited to, public safety applications, automotive applications, health logistics, and so on, in a vertical application layer. The SEAL system 100 connects to the service application system 104 through a SEAL-S interface. The SEAL-S interface may be a Common Application Programming Interface Framework (CAPIF)-2/2e complaint interface, which uses common functional Application Program Interfaces (APIs) provided by the CAPIF core function. In such a deployment, the SEAL system 100 acts as an API exposing function and the CAPIF core acts as a directory of service APIs exposed by the SEAL system 100. The SEAL-S interface that exits between the SEAL system 100 and the service application system/vertical service provider 104 may be used by the SEAL system 100 to provide the plurality of functionalities/SEAL services.

The SEAL system 100 includes a plurality of SEAL functional entities 202-216 for managing and providing the SEAL services. The SEAL system 100 possesses the corresponding SEAL functional entities on User Equipments (UEs). The SEAL functional entities 202-216 on the SEAL system 100 and User Equipments UE(s) may be grouped/classified as SEAL servers and SEAL clients.

As depicted in FIG. 2, the plurality of functional entities 202-216 may include at least one of, a group management server 202, a configuration management server 204, a location management server 206, a network resource management server 208, a security server 210, an identity management server 212, a communication server 214, and other service servers 216.

The configuration management server 204 may be configured to perform the configuration management. The location management server 206 may be configured to perform the location management. The network resource management server 208 may be configured to perform the resource management, provide multimedia, and broadcast services, or the like. The security server 210 may be configured to perform the security and key management. The identity management server 212 may be configured to perform the identity management. The identity management involves managing identity information of a member UEs in the VAL groups. The other service servers 216 may be configured to perform the other functionalities (other than those described above) specific to requirements of the service verticals offered over the 3GPP network. Operations of the functional entities 202-216 of the SEAL system 100 may be intuitively inferred by one of ordinary skill in the art based on its name or type, and thus, its detailed description is omitted.

The group management (GM) server 202 may be configured to perform the group management with respect to requirements of the vertical applications. The group management involves performing group management procedures such as, but are not limited to, create, read/access, update, delete, and so on, on one or more Vertical Application Layer (VAL) groups. The VAL group may include a group of member UEs, or users configured for a specific purpose in the SEAL service. The VAL group may be identified using a VAL group identifier (ID). The VAL group may be as defined in the 3GPP TS 3GPP TS 23.434. The group of member UEs of the VAL group may also be referred as VAL UEs and the users of the VAL group may also be referred as VAL users. The terms SEAL group and VAL group mean the same and are used interchangeably throughput this document. Embodiments herein use the terms such as “group management server”, “SEAL group management server”, “SEAL GM server”, and so on, interchangeably to refer to a server/entity that performs the group management on the one or more VAL groups.

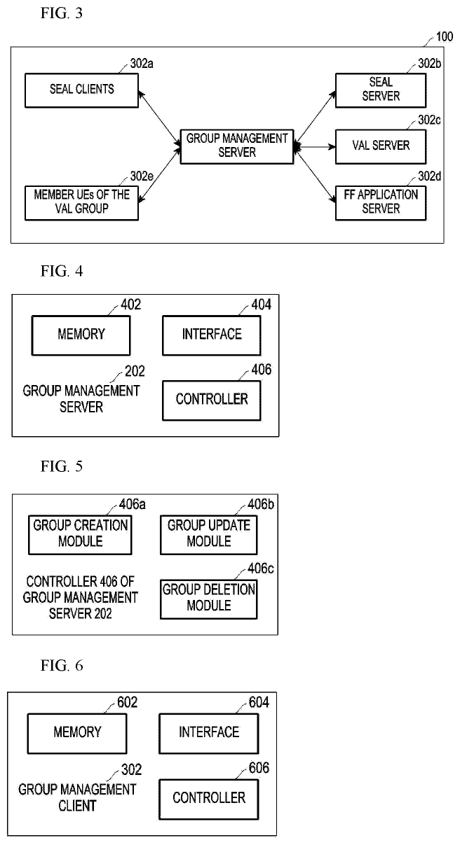

As depicted in FIG. 3, the group management server 202 may be connected to SEAL clients 302a, one or more SEAL servers 302b, a VAL server 302c, a Factory of Future (FF) application server 302d, the group of member UEs of the VAL group 302e, an authorized UE from the member UEs of the VAL group, and so on. The SEAL clients 302a may include at least one of, an administrator, an authorized user, an authorized UE, a VAL client, a SEAL client, or the like. In an embodiment herein, the FF application server 302d maps to the VAL server 302c defined in the 3GPP TS 23.434 and the vertical specific applications. Thus, in an embodiment, the terms “VAL server”, the “FF application server”, and “vertical specific application server” mean the same and are used interchangeably throughput this document.

In an embodiment herein, the SEAL clients 302a, the SEAL servers 302b, the VAL server 302c, the FF application server 302d, and the group of member UEs of the VAL group 302e may be collectively referred as group management clients 302.

The group management clients 302 may communicate with the group management server 202 using suitable reference points/interfaces. In an example, the SEAL clients 302a may communicate with the group management server 202 over a GM-UU reference point. In another example, the VAL server 302c may communicate with the group management server 202 over a GM-S reference point.

The group management clients 302 may also communicate with each other using suitable reference points/interfaces. In an example, the VAL client may access the VAL server 302c using a VAL-UU reference point. In another example, the SEAL client may access the SEAL server 302b over a SEAL-UU reference point. In another example, the SEAL server 302b may interact with another SEAL server over a SEAL-X interface.

Embodiments herein enable group management server 202 to manage the VAL group(s) by fetching, updating, and deleting external group identifier information. The external group identifier information identifies the group of member UEs for the VAL group(s) at the 3GPP core network 102. The external group identifier information corresponding to the group of member UEs of the VAL group may be used by the group management clients for invocations of Network Exposure Function (NEF)/Service Capability Exposure Function (SCEF) APIs. The external group identifier information depicts an external group identifier identifying the group of member UEs of one or more subscriptions associated to a group of International Mobile Subscriber Identities (IMSIs). The external group identifier (“ExternalGroupId”) is defined in the 3GPP TS 23.682. Embodiments herein use the terms such as “external group identifier information”, “external group identifier”, “ExternalGroupId”, “external group ID”, and so on, interchangeably through the document.

The group management server 202 receives a request from the group management client 302 for creating the VAL group(s). In an example, the request received from the group management client 302 may be a group creation request, if the group management client 302 is the authorized UE/SEAL client 302a. In another example, the request received from the group management client 302 may be a location-based group creation request for creating the VAL group, wherein the VAL group is a location-based VAL group. In another example, the request received from the group management client 302 may be a configure VAL group request, if the group management client 302 includes one of, the VAL server 302c and the FF application server 302d.

In response to the received request for creation of the VAL group, the group management server 202 creates the VAL group and obtains the external group identifier information for the created VAL group.

If the received request for creation of the VAL group is the group creation request, the group management server 202 creates the VAL group(s) in accordance with a group creation procedure specified in the 3GPP TS 23.434. The group management server 202 obtains the external group identifier information for identifying the group of member UEs of the at least one VAL group at the 3GPP core network.

If the received request is the location-based group creation request, the group management server 202 identifies a list of UEs associated with a location specified in the location-based group creation request by accessing the location management server 206. The group management server 202 determines the identified list of UEs as the group of member UEs for the location-based VAL group. The group management server 202 creates the VAL group (i.e., the location-based VAL group) and obtains the external group identifier information identifying the group of member UEs for the location-based VAL group at the 3GPP core network 102. The group management server 202 creates the VAL group in accordance with the group creation procedure specified in the 3GPP TS 23.434.

If the received request is the configure VAL request, the group management server 202 creates the VAL group in accordance with the group creation procedure specified in the 3GPP TS 23.434. The group management server 202 announces the creation of the VAL group to the SEAL clients 302a/UEs. In response to announcement, the group management server 202 receives a registration request from the one or more UEs to register with the created VAL group. The group management server 202 records the registered UEs as the group of member UEs for the VAL group and obtains the external group identifier information for the group of member UEs of the VAL group from the 3GPP core network 102.

On obtaining the external group identifier information for the VAL group, the group management server 202 stores the obtained external group identifier information corresponding to the identified group of member UEs for the VAL group in group related configuration information of the VAL group (SEAL group document or VAL group document). The terms “group related configuration information”, “SEAL group document”, and “VAL group document” mean the same and are used interchangeably throughput this document. In an embodiment, the group management server 202 may not include the obtained external group identifier information for the VAL group in the associated VAL group document, when the group management server 202 wants to share the VAL group document with the group management client 302. In an embodiment, the group management server 202 maintains a mapping between the VAL group ID and the external group identifier in a different document and not part of the VAL group document.

On obtaining and storing the external group identifier information corresponding to the identified group of member UEs of the VAL group, the group management server 202 sends a creation response to the group management client 302. In an example, the creation response may be a group creation response, if the received request is the group creation request. In another example, the creation response may be a location-based group creation response, if the received request is the location-based group creation request. In another example, the creation response may be a VAL group response, if the received request is the VAL group request.

In an embodiment, the group management server 202 may also be configured to update the VAL group(s) on updating the group of member UEs in the VAL group(s). Updating the group of member UEs in the VAL group includes updating the group of member UEs in the VAL group, on receiving a group membership update request from the group management client 302. Alternatively, updating the group of member UEs in the VAL group includes deregistering one or more member UEs of the group of member UEs from the VAL group, on receiving a group de-registration request from the group management client 302. The group management client 302 may send the de-registration request to the group management server 202, when the group management client 302 wants to leave the VAL group.

For updating the VAL group, the group management server 202 obtains updated external group identifier information identifying the updated group of member UEs of the VAL group at the 3GPP core network 102. The group management server 202 updates the group related configuration information of the VAL group based on the updated external group identifier information corresponding to the updated group of member UEs. In an example, the updated external group identifier information includes new external group identifier information, if the updated VAL group is not assigned with the external group identifier information. In another example, the updated external group identifier information includes the same external group identifier information assigned for the at least one VAL group before updating. In another example, the updated external group identifier information may be the external group identifier information different from the external group identifier information assigned for the VAL group before updating.

In an embodiment, the group management server 202 may also be configured to delete the VAL group, when the group management client 302 wants to leave the VAL group. On deleting the VAL group, the group management server 202 deletes the external group identifier information associated with the deleted VAL group, based on an assistance received from the 3GPP core network 102.

The group management client 302 may be configured to invoke one or more APIs related to the group of member UEs of the VAL group using the associated external group identifier information. The group management client 302 includes one of, the VAL server 302c, the SEAL server 302b, and the FF application server 302d. Examples of the APIs may be, but are not limited to, a NEF API, a SCEF API, and so on.

Embodiments herein also enable the FF application server 302d (comprising an FF application specific server, and an FAE server) to obtain the external group identifier information from the 3GPP core network 102. The FF application server 302d includes the obtained external group identifier information in the group creation request sent to the group management server 202 at the time of group creation. Alternatively, the FF application server 302d includes the obtained external group identifier information in the group update request sent to the group management server 202 at the time of group update. The group management server 202 includes the received external group identifier information from the FF application server 302d in the SEAL group document. Thus, providing the mapping of the VAL group to the 3GPP core network known external group identifier information. The mapping may be used by the SEAL server 302b or the FF application server 302d for invoking the NEF/SCEF APIs related to the VAL group.

The FF application server 302d in conjunction with the 3GPP core network 102 may define the external group identifier information (“ExternalGroupId”) (as defined in the 3GPP TS 23.682) identifying the group of member UEs within the VAL group. Further, the FF application server 302d also includes the defined external group identifier information in the group creation request, or the group update request sent to the group management server 202. The group management server 202 stores the received external group identifier information within the SEAL group document.

The SEAL server 302b or the FF application server 302d may fetch the external group identifier information from the group management server 202 using the VAL group ID. The SEAL server 302b or the FF application server 302d may use the external group identifier information for any NEF/SCEF APIs invocations for UE reachability, location, and so on (as specified in the 3GPP TS 29.522 and the 3GPP TS 29.122).

The FF application server 302d/VAL server 302c may also fetch or update the external group identifier information with the assistance from the 3GPP core network 102, at any point of time. The FF application server 302d includes the external group identifier information in the group creation request and the group update request sent to the group management server 202.

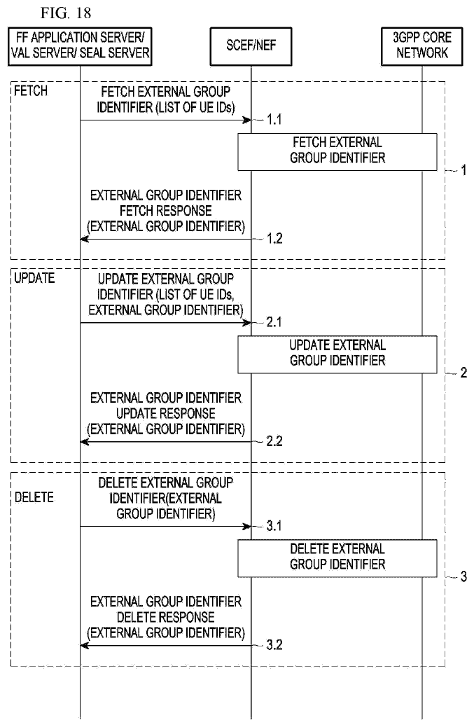

The FF application server 302d/VAL server 302c may also be enabled to perform the group management procedures such as, create, update, delete, or the like on the VAL group, by fetching, updating, and deleting the external group identifier information (corresponding to the group of member UEs) from the 3GPP core network 102. In an example, the FF application server 302d may fetch, update, and delete the external group identifier information from the 3GPP core network 102 using an online method (as depicted in FIG. 18). In another example, the FF application server may fetch, update, and delete the external group identifier information from the 3GPP core network 102 using the offline method that is based on the agreement between the vertical/SEAL service provider 104 and a Public Land Mobile Network (PLMN) operator.

Embodiments herein also enable the VAL server 302c or the FF application server 302d or the SEAL server 302b to define the external group identifier information with the assistance from the 3GPP core network 102.

Embodiments herein also enable the group management server 202 to allow the FF application server 302d/VAL server 302c/SEAL server 302b to fetch the external group identifier information related to the VAL group identified by the VAL group ID.

Embodiments herein also enable the group management server 202 to allow the FF application server 302d/VAL server 302c/SEAL server 302b to fetch information of the VAL group based on the associated external group identifier information. In an embodiment herein, the information of the VAL group may be referred as VAL group information through the document. The VAL group information includes at least one of, a VAL group ID, member UEs/users of the VAL group, VAL group configuration information, or the like.

FIGS. 1, 2, and 3 show exemplary blocks of the SEAL system 100, but it is to be understood that other embodiments are not limited thereon. In other embodiments, the SEAL system 100 may include less or more number of blocks. Further, the labels or names of the blocks are used only for illustrative purpose and does not limit the scope of the embodiments herein. One or more blocks can be combined together to perform same or substantially similar function in the SEAL system 100.

FIG. 4 is an example block diagram depicting components of the group management server 202 to enhance the SEAL services by supporting the external group identifier information for the VAL group, according to embodiments as disclosed herein. The group management server 202 includes a memory 402, an interface 404, and a controller 406.

The memory 402 may store information such as, but are not limited to, the external group identifier information in the VAL group document, the VAL group ID, and so on. Examples of the memory 402 may be, but are not limited to, NAND, embedded Multimedia Card (eMMC), Secure Digital (SD) cards, Universal Serial Bus (USB), Serial Advanced Technology Attachment (SATA), solid-state drive (SSD), and so on. The memory 402 may also include one or more computer-readable storage media. The memory 402 may also include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 402 may, in some examples, be considered a non-transitory storage medium. The term “non-transitory” may indicate that the storage medium is not embodied in a carrier wave or a propagated signal. However, the term “non-transitory” should not be interpreted to mean that the memory 402 is non-movable. In some examples, the memory 402 can be configured to store larger amounts of information than the memory. In certain examples, a non-transitory storage medium may store data that can, over time, change (e.g., in Random Access Memory (RAM) or cache).

The interface 404 may be configured to enable the group management server 202 to communicate with the group management client 302, the 3GPP core network 102, the service application system 104, and so on, over the suitable interface/reference points. Examples of the interface/reference points may be, but are not limited to, the SEAL-S interface (to communicate with the service application system 104), the 3GPP interface (to communicate with the 3GPP core network 102), the GM-UU reference point, the GM-S reference point, the VAL-UU reference point, the SEAL-UU reference point, the SEAL-X interface, and so on.

The controller 406 includes at least one of, a single processer, a plurality of processors, multiple homogeneous or heterogeneous cores, multiple Central Processing Units (CPUs) of different kinds, microcontrollers, special media, and other accelerators. The controller 406 may be configured to manage creation of the VAL groups by fetching/obtaining the external group identifier information for the VAL groups from the 3GPP core network 102. The controller 406 may also be configured to perform the group management procedures such as, update, delete, or the like on the VAL groups.

As depicted in FIG. 5, the controller 406 includes a group creation module 406a, a group update module 406b, and a group deletion module 406c.

The group creation module 406a may be configured to manage creation of the VAL group. The group creation module 406a creates the VAL group, on receiving the request from the group management client 302 for creation of the VAL group. In an example, the request may be the group creation request from the SEAL client 302a. In another example, the request may be the location-based group creation request from the SEAL client 302a or the VAL server 302c, or the FF application server 302d. On creating the VAL group, the group creation module 406a obtains the external group identifier information identifying the group of member UEs for the VAL group from the 3GPP core network 102. The group creation module 406a stores the external group identifier information obtained for the VAL group in the VAL group document. On obtaining and storing the external group identifier information, the group creation module 406a sends the creation response to the group management client 302 indicating the successful creation of the VAL group.

The group update module 406b may be configured to update the VAL group. The group update module 406b receives the group membership update request or the group de-registration request from the group management server 202 for updating or deregistering the VAL group, respectively. The group update module 406b updates the membership/subscriptions of the member UEs of the VAL group or de-registers the one or more member UEs from the VAL group, based on the received group membership update request or the group de-registration request, respectively. On updating the member UEs of the VAL group or de-registering the one or more member UEs from the VAL group, the group update module 406b obtains the updated external group identifier information identifying the updated group of member UEs of the VAL group at the 3GPP core network 102. The group management server 202 updates the group related configuration information/VAL group document of the VAL group based on the updated external group identifier information corresponding to the updated group of member UEs.

The group deletion module 406c may be configured to delete the VAL group, when the group management client 302 wants to leave the VAL group. On deleting the VAL group, the group deletion module 406c deletes the external group identifier information associated with the deleted VAL group, based on an assistance received from the 3GPP core network 102.

FIGS. 4 and 5 show exemplary blocks of the group management server 202, but it is to be understood that other embodiments are not limited thereon. In other embodiments, the group management server 202 may include less or more number of blocks. Further, the labels or names of the blocks are used only for illustrative purpose and does not limit the scope of the embodiments herein. One or more blocks can be combined together to perform same or substantially similar function in the group management server 202.

FIG. 6 is an example block diagram depicting components of the group management client 302 for invoking the APIs, according to embodiments as disclosed herein. The group management client includes a memory 602, an interface 604, and a controller 606.

The memory 602 may store information such as, but are not limited to, the external group identifier information of the VAL group, the VAL group ID, and so on. Examples of the memory 602 may be, but are not limited to, NAND, embedded Multimedia Card (eMMC), Secure Digital (SD) cards, Universal Serial Bus (USB), Serial Advanced Technology Attachment (SATA), solid-state drive (SSD), and so on. The memory 602 may also include one or more computer-readable storage media. The memory 602 may also include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 602 may, in some examples, be considered a non-transitory storage medium. The term “non-transitory” may indicate that the storage medium is not embodied in a carrier wave or a propagated signal. However, the term “non-transitory” should not be interpreted to mean that the memory 602 is non-movable. In some examples, the memory 602 can be configured to store larger amounts of information than the memory. In certain examples, a non-transitory storage medium may store data that can, over time, change (e.g., in Random Access Memory (RAM) or cache).

The interface 604 may be configured to enable the group management client 302 to communicate with the group management server 202 and another group management client 302 over the suitable interface/reference points. Examples of the interface/reference points may be, but are not limited to, the GM-UU reference point, the GM-S reference point, the VAL-UU reference point, the SEAL-UU reference point, the SEAL-X interface, and so on.

The controller 606 includes at least one of, a single processer, a plurality of processors, multiple homogeneous or heterogeneous cores, multiple Central Processing Units (CPUs) of different kinds, microcontrollers, special media, and other accelerators. The controller 606 may be configured to invoke the APIs related to the VAL group. For invoking the APIs, the controller 606 fetches the external identifier group information of the VAL group using the VAL group ID. The controller 606 uses the fetched external identifier group information of the VAL group to invoke the APIs (such as the NEF API, the SCEF API, or the like) related to the VAL group.

The controller 606 may also be configured to fetch the information of the VAL group based on the external identifier information of the VAL group.

FIG. 6 shows exemplary blocks of the group management client 302, but it is to be understood that other embodiments are not limited thereon. In other embodiments, the group management client 302 may include less or more number of blocks. Further, the labels or names of the blocks are used only for illustrative purpose and does not limit the scope of the embodiments herein. One or more blocks can be combined together to perform same or substantially similar function in the group management client 302.

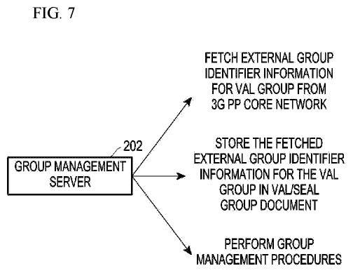

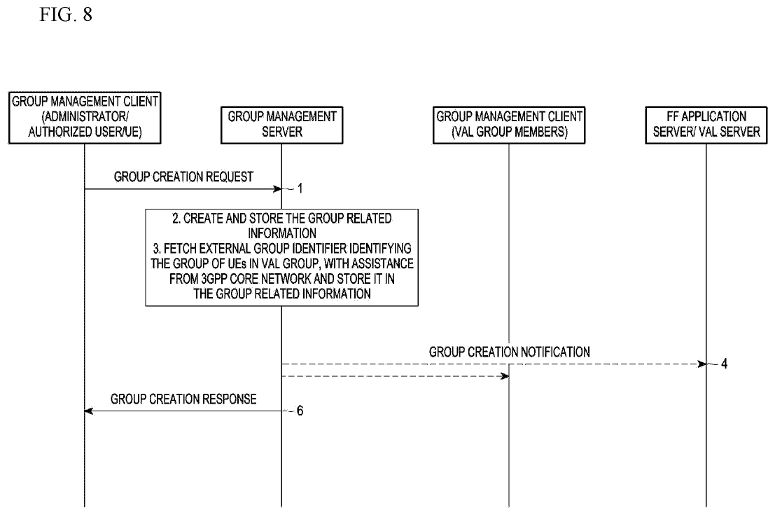

FIG. 7 is an example conceptual diagram depicting enhancement of the SEAL services by supporting the external group identifier information for the VAL group, according to embodiments as disclosed herein.

In an embodiment, the group management server 202 obtains the external group identifier information from the 3GPP core network 102 and includes the fetched external group identifier information in the SEAL/VAL group document at the time creating the VAL group or updating the VAL group. The external group identifier information identifies the group of member UEs in the VAL group at the 3GPP core network. Obtaining and storing the external group identifier information provides a mapping of the VAL group to the 3GPP core network known external group identifier, which can then be used by the group management server 202 like the SEAL server 302b or the FF application server 302d for invoking any SCEF/NEF APIs related to the VAL group. When a new VAL group is created or an existing VAL group is modified at the group management server 202, the 3GPP core network 102 defines the external group identifier for the VAL group in conjunction with the group management server 202. The group management server 202 identifies the group of member UEs for the new or modified VAL group from the 3GPP core network 102 and obtains and stores the external group identifier information corresponding to the group of member UEs within the SEAL group document.

In an embodiment, the group management server 202 may fetch the external group identifier information identifying the group of member UEs in the VAL group from the 3GPP core network 102 at any point of time. The group management server 202 may also update the SEAL group document with the fetched external group identifier information and notify the FF application server 302d about the updated SEAL group document. The SEAL server 302b or the FF application server 302d coupled with the group management server 202 may fetch the external group identifier information from the group management server 202 using the VAL group ID. The SEAL server 302b or the FF application server 302d may use the external group identifier information for invoking any NEF/SCEF APIs for UE reachability, location, and so on, as specified in the 3GPP TS 29.522, TS 29.122, and like so. The SEAL server 302b or the FF application server 302d may use the external group identifier information for invoking any NEF/SCEF APIs for the vertical applications such as, but are not limited to, Application layer support for Unmanned Aerial System (UASAPP), application layer support for V2X services (V2XAPP), enhancements to application layer support for V2X services (eV2XAPP) and so on, by fulfilling specific requirements of the vertical applications.

In an embodiment, the group management server 202 may perform the group management procedures such as, create, update, delete, or the like on the VAL group, by fetching, updating, and deleting the external group identifier information corresponding to the group of member UEs from the 3GPP core network 102. In an example, the group management server 202 may fetch, update, and delete the external group identifier information from the 3GPP network using the online method. Fetching, updating, and deleting the external group identifier information from the 3GPP core network 102 using the online method is described in detail in conjunction with FIG. 18. In an example, the group management server 202 may fetch, update, and delete the external group identifier information from the 3GPP core network 102 using the offline method that is based on an agreement between the vertical/SEAL service provider 104 and a Public Land Mobile Network (PLMN) operator.

FIG. 8 is a sequence diagram depicting creation of the VAL group supporting the external group identifier information, according to embodiments as disclosed herein.

At step 1, the group management server 202 receives the group creation request from the group management client 302. The group management client 302 may include one of the SEAL clients 302a such as, the administrator, the authorized UE, the authorized user, or the like.

At step 2, the group management server 202 creates the VAL group in response to the received group creation request. The group management server 202 creates the VAL group in accordance with the group creation procedure as specified in the 3GPP TS 23. 434.

At step 3, the group management server 202 fetches the external group identifier information identifying the group of member UEs of the VAL group at the 3GPP core network 102 and stores the fetched external group identifier information in the VAL group document of the VAL group.

At step 4, the group management server 202 sends a group creation notification to the FF application server 302d and/or the VAL server 302c. The group creation notification indicates the creation of the VAL group. The group management server 202 also sends the group creation notification to the group of member UEs of the VAL group.

At step 6, the group management server 202 sends the group creation response to the group management client 302 indicating the creation of the VAL group in response to the received group creation request.

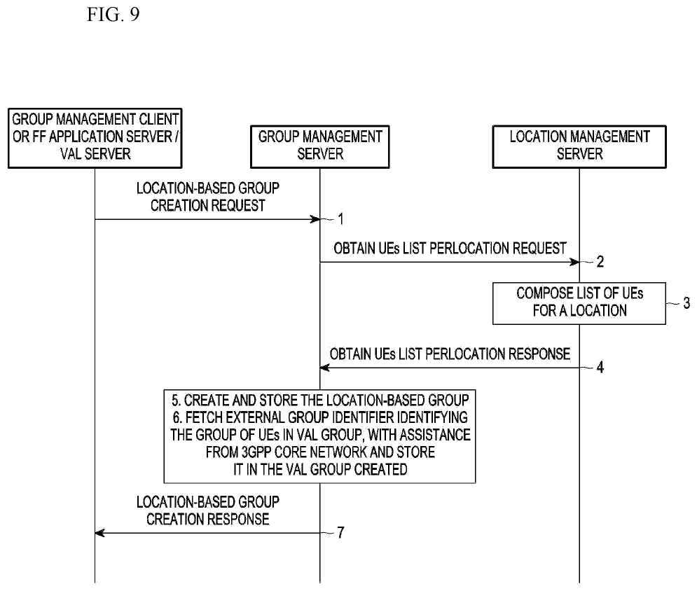

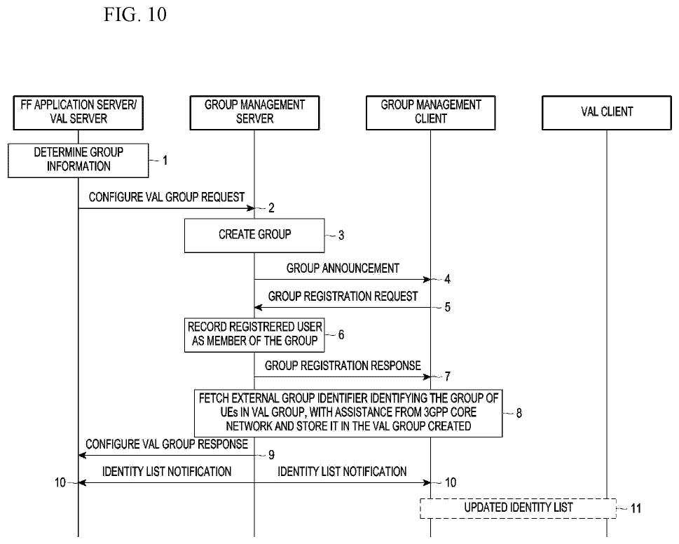

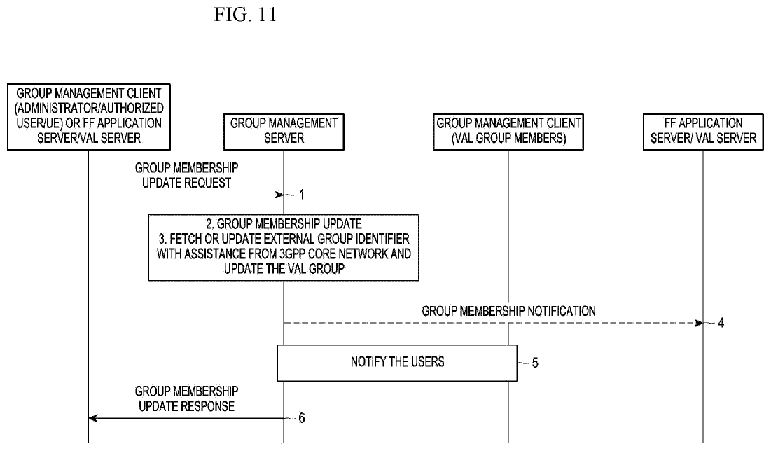

FIG. 9 is an example sequence diagram depicting creation of the VAL group supporting the external group identifier information, wherein the VAL group is the location-based VAL group, according to embodiments as disclosed herein.

At step 1, the group management server 202 receives the location-based group creation request from the group management client 302 or the FF application server 302d or the VAL server 302c.

At step 2, the group management server 202 queries the location management server 206 for the list of UEs for the location specified in the location-based group creation request. At step 3, the location management server 206 composes the list of UEs for the queried location from the group management server 202. At step 4, the location management server 206 communicates the composed list of UEs to the group management server 202.

At step 5, the group management server 202 creates the VAL group (i.e., the location-based VAL group). The group management server 202 creates the location-based VAL group in accordance with the group creation procedure specified in 3GPP TS 23.434. At step 6, the group management server 202 determines the UEs received in the composed list as the group of member UEs for the created VAL group and fetches the external group identifier information for the group of member UEs from the 3GPP core network 102. The group management server 202 stores the fetched external group identifier information in the VAL group document of the created location-based VAL group. At step 7, the group management server 202 sends the location-based group creation response to the group management client 302.

FIG. 10 is an example diagram depicting creation of the VAL group on receiving the configure VAL group request, according to embodiments as disclosed herein.

At step 1, the FF application server 302d or the VAL server 302c determines group information required for creation of the VAL group. The group information includes information about the new VAL group that is to be created such as, but are not limited to, a VAL group ID, VAL group configuration information, member UEs/users of the VAL group, and so on. At step 2, the FF application server 302d or the VAL server 302c sends the configure VAL group request to the group management server 202.

At step 3, the group management server 202 creates the VAL group in response to the received configure VAL group request. The group management server 202 creates the VAL group in accordance with the group creation procedure specified in the 3GPP TS 23.434. At step 4, the group management server 202 makes a group announcement to the group management client/UEs, indicating the creation of the VAL group. At step 5, the group management server 202 receives a group registration request from the UEs to register with the VAL group. At step 6, the group management server 202 records the registered UEs as the group of member UEs for the created VAL group. At step 7, the group management server 202 sends a group registration response to the registered UEs.

At step 8, the group management server 202 fetches the external group identifier information from the 3GPP core network 102 for the list of UEs that register as the group of member UEs for the VAL group and stores the fetched external group identifier information in the newly VAL group document of the created VAL group. In an example, the step 8 may be performed by the group management server 202 after all the group management clients/UEs have been registered to the VAL group. In another example, the step 8 may be performed by the group management server 202 after a pre-determined time period. Thereby, the group management server 202 may perform the step 8, instead of waiting for all the member UEs to register to the group (i.e., irrespective of trigger of all the member UEs responding to join the group).

At step 9, the group management server 202 sends the configure VAL group response to the FF application server 302d or the VAL server 302c, on obtaining and storing the external group identifier information in the VAL group document.

At step 10, an identity list notification may be exchanged between the FF application server 302d or the VAL server 302c and the group management clients/UEs 302a. At step 11, an updated identity list may be provided to the VAL client. The identity list notification indicates about the newly registered users to the other member of the VAL group and the VAL server 302c, as defined in the 3GPP TS 23.434.

FIG. 11 is an example diagram depicting updating of the VAL group, according to embodiments as disclosed herein.

At step 1, the group management server 202 receives the group membership update request from the group management client 302. The group management client 302 includes one of, the administrator, the authorized UE/user, the FF application server 302d, the VAL server 302c, or the like.

At step 2, the group management server 202 updates membership of the group of member UEs of the VAL group, on receiving the group membership update request. The group management server 202 updates the membership of the group of member UEs in accordance with a SEAL group membership update procedure as specified in the 3GPP TS 23.434.

At step 3, the group management server 202 fetches or updates the external group identifier information with the assistance from the 3GPP network 102 and updates the VAL group with the newly fetched or the updated external group identifier information. If the VAL group does not have the external group identifier information, then the group management server 202 fetches the new external group identifier information. Otherwise, the group management server 202 may update the current external group identifier information in the VAL group with the updated set of group of member UEs or fetch another external group identifier information matching the updated set of group of member UEs.

At step 4, the group management server 202 sends a group membership notification to the FF application server 302d or the VAL server 302c, on updating the VAL group. At step 5, the group management server 202 notifies the group of member UEs of the VAL group about the update of the VAL group. At step 6, the group management server 202 sends the group membership update response to the group management client 302.

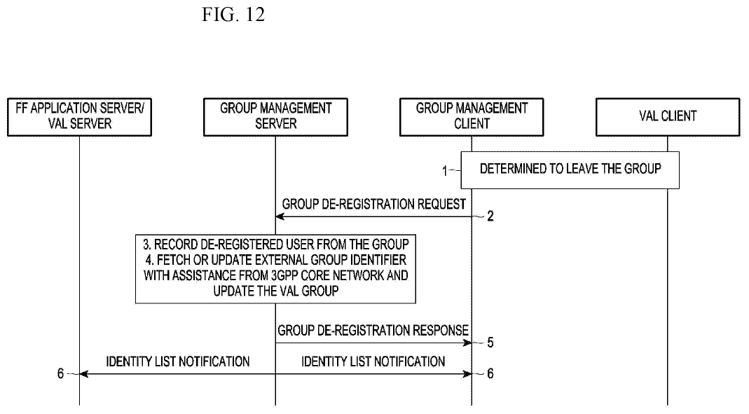

FIG. 12 is an example sequence diagram depicting de-registration of the VAL group, according to embodiments as disclosed herein.

At step 1, the VAL client/at least one member UE of the VAL group wants to leave the VAL group. At step 2, the member UE of the VAL group sends a group de-registration request to the group management server 202.

In response to the received group de-registration request, at step 3, the group management server 202 de-registers the member UE from the VAL group and records the de-registered UE from the VAL group. The group management server 202 de-registers the member UE from the VAL group in accordance with a SEAL group member leave procedure as specified in the 3GPP TS 23.434. At step 4, the group management server 202 fetches or updates the external group identifier information with the assistance from 3GPP core network 102 and updates the VAL group with the newly fetched or updated external group identifier information. In an embodiment herein, the steps 4 and 5 may be performed in any order. If the VAL group does not have external group identifier information, then the group management server 202 fetches the new external group identifier information. Otherwise, the group management server 202 updates the current external group identifier information in the VAL group with the updated set of group of member UEs or fetch another external group identifier information matching the updated set of group of member UEs. On de-registering the UE from the VAL group, the group management server 202 deletes the VAL group as specified in the 3GPP TS 23.434. If the deleted VAL group has the external group identifier information, the group management server 202 deletes the external group identifier information with the assistance from the 3GPP core network 102.

At step 5, the group management server 202 sends a group de-registration response to the group management client/SEAL client/member UEs of the VAL group 302. At step 6, the identity list notification may be exchanged between the member UEs of the VAL group and the FF application server 302d/VAL server 302c.

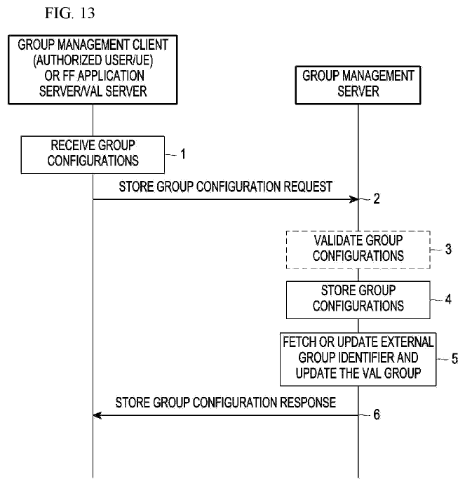

FIG. 13 is an example sequence diagram depicting fetching or updating the external group identifier information during a store group configuration procedure, according to embodiments as disclosed herein.

At step 1, the group management client 302 (the authorized user/UE, or the FF application server 302d or the VAL server 302c) receives group configurations of the VAL group. The group configurations/VAL group configuration information may include the updated list of member UEs of the VAL group. At step 2, the group management client 302 sends a group configuration request to the group management server 202. At step 3, the group management server 202 validates the group configurations. On successfully validating the group configurations, at step 4, the group management server 202 stores the group configurations, in accordance with a store group configuration procedure as specified in the 3GPP TS 23.434. At step 5, based on the stored group configurations, the group management server 202 fetches or updates the external group identifier information with the assistance from the 3GPP core network 102 and updates the VAL group with the fetched or updated external group identifier information. If the VAL group has deleted and the deleted VAL group has the external group identifier information, the group management server 202 deletes the external group identifier information with the assistance from the 3GPP core network 102.

At step 6, the group management server 202 sends a store group configuration response to the group management client 302 indicating the storage of the group configurations.

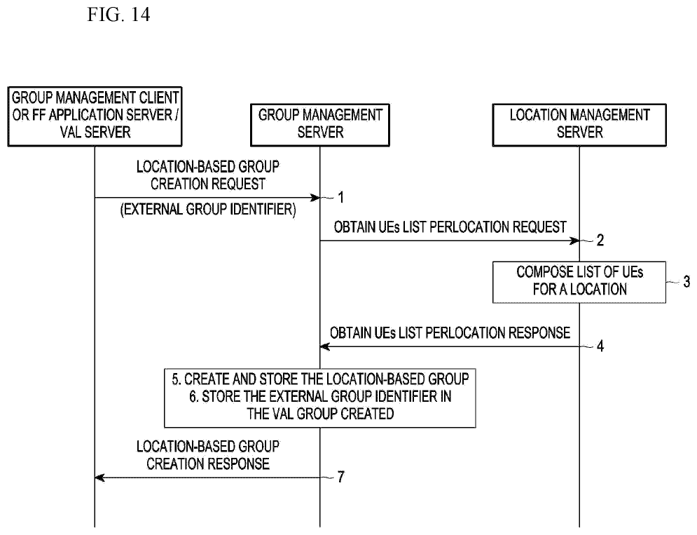

FIG. 14 is an example sequence diagram depicting creation of the location-based VAL group based on the group creation request including the external group identifier information, according to embodiments as disclosed herein.

At step 1, the group management client 302 (the FF application server 302d or the VAL server 302c) sends the location-based group creation request to the group management server 202 for the creation of the location-based VAL group. In an embodiment herein, the location-based group creation request includes the external group identifier information along with other parameters. The other parameters may be applicable parameters as specified for “Location-based group creation request” message in the 3GPP TS 23. 434, clause 10.3.2.34.

At step 2, the group management server 202 queries the location management server 206 for the list of UEs for the location specified in the location based group creation request. At step 3, the location management server 206 composes the list of UEs for the queried location from the group management server 202. At step 4, the location management server 206 communicates the composed list of UEs to the group management server 202.

At step 5, the group management server 202 creates the location-based VAL group. The group management server 202 creates the location-based VAL group in accordance with the group creation procedure specified in the 3GPP TS 23.434. At step 6, the group management server 202 stores the external group identifier information received from the FF application server 302d (at step 1) in the VAL group document of the created VAL group. At step 7, the group management server 202 sends the location-based group creation response to the group management client 302.

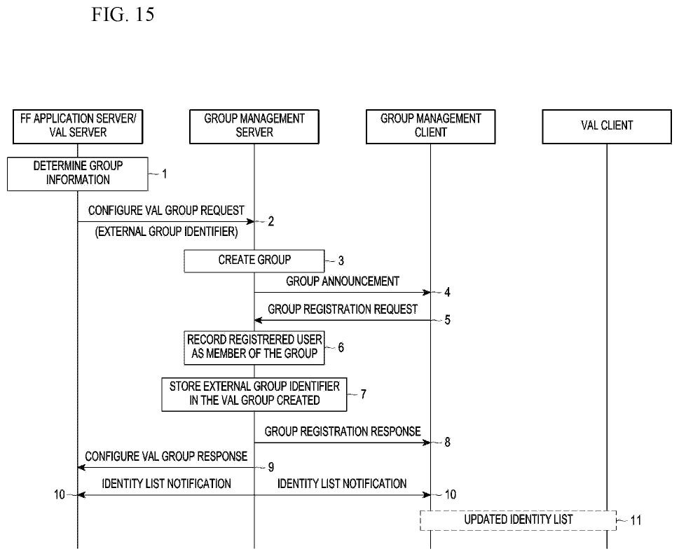

FIG. 15 is an example diagram depicting creation of the VAL group on receiving the configure VAL group request including the external group identifier information, according to embodiments as disclosed herein.

At step 1, the FF application server 302d or the VAL server 302c determines the group information required for creation of the VAL group. At step 2, the FF application server 302d or the VAL server 302c sends the configure VAL group request to the group management server 202. In an embodiment herein, the configure VAL group request includes the external group identifier information along with other applicable parameters (as defined in the 3GPP TS 23.434).

At step 3, the group management server 202 creates the VAL group in response to the received configure VAL group request. The group management server 202 creates the VAL group in accordance with the group creation procedure specified in the 3GPP TS 23.434. At step 4, the group management server 202 makes the group announcement to the group management client/UEs, indicating the creation of the VAL group. At step 5, the group management server 202 receives the group registration request from the UEs to register with the VAL group. At step 6, the group management server 202 records the registered UEs as the group of member UEs for the created VAL group.

At step 7, the group management server 202 stores the received external group identifier information from the FF application server 302d (at step 2) in the newly VAL group document of the created VAL group. At step 7, the group management server 202 sends the group registration response to the registered UEs.

In an example, the steps 7 and 8 may be performed by the group management server 202 in any order.

At step 9, the group management server 202 sends the configure VAL group response to the FF application server 302d or the VAL server 302c, on storing the external group identifier information in the VAL group document.

At step 10, the identity list notification may be exchanged between the FF application server 302d or the VAL server 302c and the SEAL clients 302a/UEs. At step 11, the updated identity list may be provided to the VAL client.

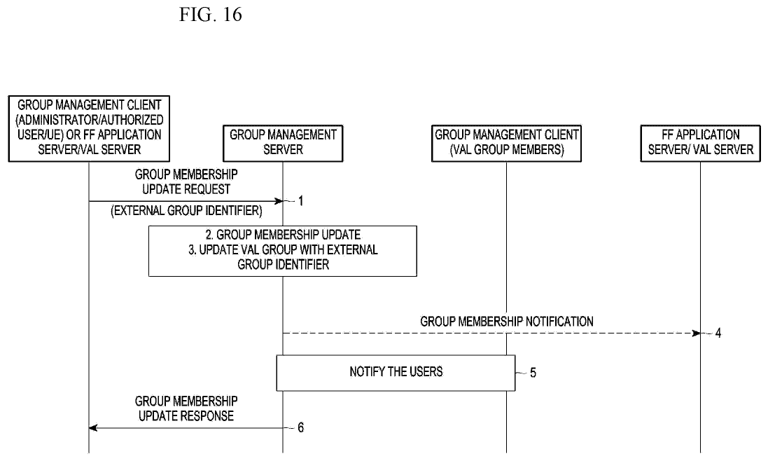

FIG. 16 is an example diagram depicting updating of the VAL group based on the group membership update request including the external group identifier information, according to embodiments as disclosed herein.

At step 1, the group management server 202 receives the group membership update request from the group management client 302. In an embodiment, the group management client 302 includes the external group identifier information along with other applicable parameters in the group membership update request. The group management client 302 includes one of, the administrator, the authorized UE/user, the FF application server 302d, the VAL server 302c, or the like.

At step 2, the group management server 202 updates the membership of the group of member UEs of the VAL group, on receiving the group membership update request. The group management server 202 updates the membership of the group of member UEs in accordance with the SEAL group membership update procedure as specified in the 3GPP TS 23.434.

Once updating the member of the group of member UEs is successful, at step 3, the group management server 202 updates the VAL group with the external group identifier information received in the group membership update request from the FF application server 302d.

At step 4, the group management server 202 sends the group membership notification to the FF application server 302d or the VAL server 302c, on updating the VAL group. At step 5, the group management server 202 notifies the group of member UEs of the VAL group about the update of the VAL group. At step 6, the group management server 202 sends the group membership update response to the group management client 302.

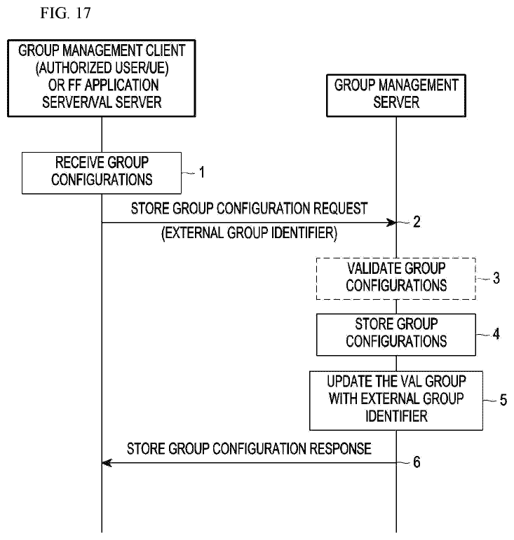

FIG. 17 is an example sequence diagram depicting performing the store group configuration procedure based on the store group configuration request including the external group identifier information, according to embodiments as disclosed herein.

At step 1, the group management client 302 (the authorized user/UE, or the FF application server 302d or the VAL server 302c) receives the group configurations of the VAL group. At step 2, the group management client 302 sends the group configuration request including the external group identifier information to the group management server 202. At step 3, the group management server 202 validates the group configurations. On successfully validating the group configurations, at step 4, the group management server 202 stores the group configurations, in accordance with the store group configuration procedure as specified in the 3GPP TS 23.434. At step 5, based on the stored group configurations, the group management server 202 updates the VAL group with the external group identifier information received from the group management client 302. If the VAL group has been deleted and the deleted VAL group has the external group identifier information, the group management server 202 notifies the FF application server 302d with group deletion information. On receiving the group deletion information, the FF application server 302d deletes the external group identifier information with the assistance from the 3GPP core network 102.

At step 6, the group management server 202 sends the store group configuration response to the group management client 302 indicating the storage of the group configurations.

FIG. 18 is an example sequence diagram depicting procedures for the FF application server 302d or the VAL server 302c or the SEAL server 302b to fetch, update, and delete the external group identifier information from the 3GPP core network 102 either directly or via the NEF/SCEF entity, according to embodiment as disclosed herein.

The FF application server 302d or the VAL server 302c or the SEAL server 302b may fetch, update, and delete the external group identifier information from the 3GPP core network 102, as defined in the 3GPP TS 23.682.

For fetching the external group identifier information, at step 1.1, the FF application server 302d/the VAL server 302c/the SEAL server 302b sends a fetch external group identifier request to the NEF/SCEF entity/API or the 3GPP core network 102 directly. The fetch external group identifier request includes a list of UE IDs, for which the external group identifier information is requested. The UE ID is either MSISDN of the UE or the external identifier as defined in the 3GPP TS 23. 682.

At step 1.2, the 3GPP core network 102 responds to the fetch external group identifier request, either directly or via NEF/SCEF entity, by providing the external group identifier information (as defined in TS 23. 682) for the set of UE Ids in the received fetch external group identifier request. The 3GPP core network 102 may create new external group identifier information or retrieve existing external group identifier information, in response to the received fetch external group identifier request.

For updating the external group identifier information, at step 2.1, the FF application server 302d/the VAL server 302c/the SEAL server 302b sends an update external group identifier request to the SCEF/NEF entity or the 3GPP core network 102 directly. The update external group identifier request includes the list of UE Ids and the external group identifier information, which has to be updated with the list of UE Ids in the request. The UE ID is either MSISDN of the UE or the external identifier as defined in the 3GPP TS 23. 682.

At step 2.2, the 3GPP core network 102 responds to the update external group identifier request, either directly or via NEF/SCEF, by providing the external group identifier information (as defined in TS 23. 682) for the set of UE Ids in the received update external group identifier request.

For deleting the external group identifier information, at step 3.1, the FF application server 302d/the VAL server 302c/the SEAL server 302b sends a delete external group identifier request to the NEF/SCEF entity or the 3GPP core network 102 directly. The delete external group identifier request includes the external group identifier information, which has to be deleted.

At step 3.2, the 3GPP core network 102 responds to the delete external group identifier request, either directly or via NEF/SCEF, by including a result of deletion of the external group identifier information (as defined in TS 23. 682).

In an embodiment, the FF application server 302d/the VAL server 302c/the SEAL server 302b fetches, updates, and deletes the external group identifier using the procedures specified in the 3GPP TS 23.501, TS 29.522.

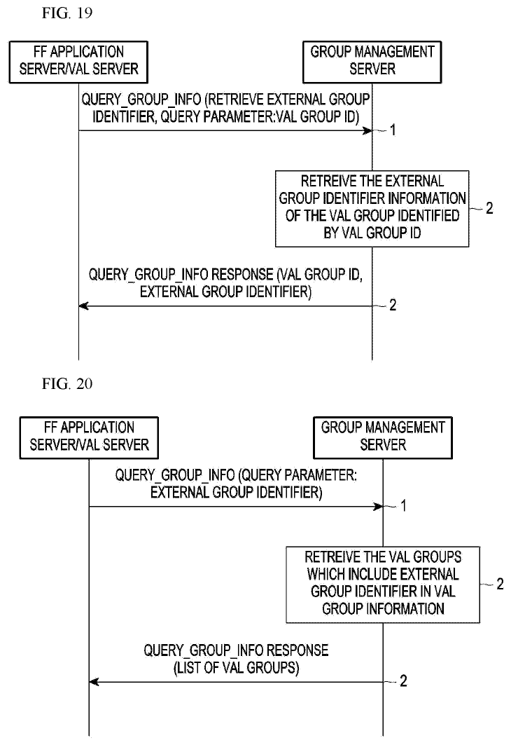

FIG. 19 is an example sequence diagram depicting retrieval of the external group identifier information from the group management server 202, according to embodiments as disclosed herein.

At step 1, the FF application server 302d/the VAL server 302c/the SEAL server 302b queries the group management server 202 for the external group identifier information related to the VAL group by sending a Query Group Info request to the group management server 202. The Query Group Info request includes a retrieve external group identifier request matching a query parameter like the VAL Group ID. At step 2, based on the query parameter (the VAL group ID) and the retrieve external group identifier request, the group management server 202 fetches the external group identifier information related to the VAL group identified by the VAL Group ID in the retrieve external group identifier request. The group management server 202 includes the external group identifier in the Query Group Info response to the FF application server 302d/the VAL server 302c/the SEAL server 302b.

FIG. 20 is an example sequence diagram depicting retrieval of the information of the VAL group (referred hereinafter as VAL group information) based on the associated external group identifier information, according to embodiments as disclosed herein.

At step 1, the FF application server 302d/the VAL server 302c/the SEAL server 302b queries the group management server 202 for the VAL group information matching the external identifier, in the Query Group Info request. The Query Group Info request includes a query parameter like the external group identifier information. At step 2, based on the query parameter, the group management server 202 retrieves the VAL groups matching the external group identifier information in the VAL group document. The group management server includes the VAL group information matching the external group identifier in the Query Group Info response to the FF application server 302d/the VAL server 302c/the SEAL server 302b.

Embodiments herein enable a group management server to consume 3GPP core network capabilities for member UEs of a VAL group with a support of an external group identifier. Associating the VAL group with the related external group identifier belonging to the 3GPP core network creates a standardized way of maintaining the mapping. Also, the VAL group information may also be used by Factories for Future (FF) application layers to consume the 3GPP core network capabilities via a NEF/SCEF directly.

The embodiments disclosed herein can be implemented through at least one software program running on at least one hardware device and performing network management functions to control the elements. The elements shown in FIGS. 1, 2, 3, 4, 5, and 6 can be at least one of a hardware device, or a combination of hardware device and software module.

The embodiments disclosed herein describe methods and systems for enhancing Service Enabler Architecture Layer (SEAL) services. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

1. A method for managing Service Enabler Architecture Layer (SEAL) services by a group management server, the method comprising:
receiving a group creation request from a group management client;
creating a Vertical Application Layer (VALI group based on the group creation request;
obtaining external group identifier information for a group of member user equipments (UEs) of the created VAL group from a core network;
storing the obtained external group identifier information in a VAL group document related to the created VAL group; and
sending a group creation response related to the created VAL group to the group management client.

2. The method of claim 1, wherein the group management client is an administrator or an authorized UE.

3-4. (canceled)

5. The method of claim 1, wherein:
in case that the group creation request is a location-based group creation request, the method further comprises obtaining a list of UEs for a location from a location management server, and creating the VAL group comprises creating a location-based VAL group based on the list of UEs.

6. (canceled)

7. The method of claim 1, further comprising:
updating the VAL group, on updating the group of member UEs in the VAL group,
wherein updating the VAL group comprises:
obtaining updated external group identifier information identifying the updated group of member UEs of the VAL group from the core network; and
updating the VAL group document related to the VAL group based on the updated external group identifier information corresponding to the updated group of member UEs.

8-10. (canceled)

11. The method of claim 1, further comprising:
deleting the VAL group, when the group management client wants to leave the VAL group; and
deleting the external group identifier information associated with the deleted VAL group, based on an assistance received from the core network.

12-13. (canceled)

14. A group management server for managing Service Enabler Architecture Layer (SEAL) services, comprising:
a memory; and
a controller coupled to the memory, wherein the controller is configured to:
receive a group creation request from a group management client,
create a Vertical Application Layer (VAL) group based on the group creation request,
obtain external group identifier information for a group of member user equipments (UEs) of the created VAL group from a core network,
store the obtained external group identifier information in a VAL group document related to the created VAL group, and
send a group creation response related to the created VAL group to the group management client.

15. (canceled)

16. The group management server of claim 14, wherein the group management client is an administrator or an authorized UE.

17. The group management server of claim 14, in case that the group creation request is a location-based group creation request, the controller is further configured to obtain a list of UEs for a location from a location management server, and for creating the VAL group the controller is configured to create a location-based VAL group based on the list of UEs.

18. The group management server of claim 14, wherein the controller is further configured to update the VAL group, on updating the group of member UEs in the VAL group, and
wherein for updating the VAL group, the controller is configured to:
obtain updated external group identifier information identifying the updated group of member UEs of the VAL group from the core network; and
update the VAL group document related to the VAL group based on the updated external group identifier information corresponding to the updated group of member UEs.

19. The group management server of claim 14, wherein the controller is further configured to:
deleting the VAL group, when the group management client wants to leave the VAL group; and
deleting the external group identifier information associated with the deleted VAL group, based on an assistance received from the core network.

20. A method for managing Service Enabler Architecture Layer (SEAL) services by a group management server, the method comprising:
receiving a configure Vertical Application Layer (VAL) group request from a server;
creating a VAL group based on the configure VAL group request;
obtaining external group identifier information for a group of member user equipments (UEs) of the created VAL group from a core network;
storing the obtained external group identifier information in a VAL group document related to the created VAL group; and
sending a configure VAL group response related to the created VAL group to the server.

21. The method of claim 20, wherein the server is a Factory of the Future (FF) application server or a VAL server.

22. A group management server for managing Service Enabler Architecture Layer (SEAL) services, comprising:
a memory; and
a controller coupled to the memory, wherein the controller is configured to:
receive a configure Vertical Application Layer (VAL) group request from a server;
create a VAL group based on the configure VAL group request;
obtain external group identifier information for a group of member user equipments (UEs) of the created VAL group from a core network;
store the obtained external group identifier information in a VAL group document related to the created VAL group; and
send a configure VAL group response related to the created VAL group to the server.

23. The group management server of claim 22, wherein the server is a Factory of the Future (FF) application server or a VAL server.
